(19) United States
(12) Patent Application Publication
(10) Pub. No.: US 2024/0245257 A1
(43) Pub. Date: Jul. 25, 2024

(54) METHOD AND APPARATUS FOR BREWING, MIXING, AND DELIVERING A BEVERAGE

(71) Applicant: Appliance Innovation, Inc., Richardson, TX (US)

(72) Inventors: PHILIP R. MCKEE, DALLAS, TX (US); LEE VANLANEN, MCKINNEY, TX (US); SCOTT SMITH, RICHARDSON, TX (US); ANDREW PODEVELS, WAUWATOSA, WI (US)

(21) Appl. No.: 18/416,469

(22) Filed: Jan. 18, 2024

Related U.S. Application Data
(63) Continuation-in-part of application No. 18/099,485, filed on Jan. 20, 2023.

(51) Int. Cl. A47J 31/50; A47J 31/52; A47J 31/56

(52) U.S. Cl. CPC A47J 31/505; A47J 31/525; A47J 31/56

(57) ABSTRACT

A method and apparatus for brewing a beverage. A beverage concentrate is brewed using hot water. The temperature of the beverage concentrate is reduced from a first temperature to a predetermined second temperature upon the brewing of the concentrate. The temperature of the beverage concentrate is further reduced from the predetermined second temperature to a third temperature. An apparatus used to brew the beverage is self-cleaning. In the apparatus, a brewed cleaning solution is recirculated, for a predetermined period of time, between a reservoir and the storage receptacles that hold beverage concentrates.

### CROSS REFERENCE TO RELATED APPLICATIONS

The present application is a continuation-in-part of U.S. patent application Ser. No. 18/099,485, filed Jan. 20, 2023, and entitled “Method and Apparatus for Brewing, Mixing, and Delivering a Beverage,” the contents of which are incorporated herein by reference in their entirety.

### FIELD OF THE INVENTION

The present invention generally relates to methods and apparatus for the preparation and delivery of a brewed beverage to a customer. In particular, the present invention relates to the automated brewing of a beverage in an apparatus that occupies a small amount of space and dispenses the brewed beverage at a relatively constant temperature.

### BACKGROUND OF THE INVENTION

Conventional commercial tea brewing and dispensing systems, such as those typically found in convenience stores, can include several brew stations (as many as six or even more), each of which brews and dispenses a different flavor of tea to customers. Each brew station typically includes two tea urns: one tea urn contains an unsweetened version of the tea and the other contains a sweetened version of the tea.

In each brewing station, and for each tea urn, hot water is poured over a tea “base” (i.e., a tea bag) to produce a tea concentrate which has a temperature of about 200° F. This tea concentrate is then diluted by mixing it with about five parts tap water (which has a temperature of about 70° F.) per one part hot tea concentrate as it fills a tea urn. If the diluted tea is to be sweetened, a sweetener is added to the sweet tea urn as the diluted tea fills that tea urn. For a flavored tea that does not require a unique tea base, the particular flavor (e.g., a flavored syrup) is added to the sweet tea urn and the unsweet tea urn as the diluted tea fills each tea urn.

The initial temperature of the diluted tea in each tea urn is about 100° F., and the diluted tea ultimately cools to room temperature, where it is held until the diluted tea is drawn from the tea urn by a customer. When the customer draws the diluted tea from the tea urn into a cup containing ice, the temperature of the diluted tea will vary between about 100° F. and about 80° F. depending on when the tea was brewed. Furthermore, if the customer draws the tea during the brewing process, the tea can have widely varying dilutions and temperatures. Also, the ice in the cup will melt differently depending on the temperature of the diluted tea when it is drawn into the cup, which will dilute the tea differently. Finally, the consistency of the diluted tea will vary depending on when it is drawn into the cup, as tea solids (such as tea leaves) will tend to settle at the bottom of the tea urn over time if the diluted tea is not drawn from the tea urn.

The diluted tea maintains a “fresh brew” quality for only about ninety minutes, and then begins to deteriorate due to microbial growth occurring in the tea. The diluted tea shows signs of degradation in quality about three hours after brewing and the degradation continues until the diluted tea must be discarded due to unacceptable quality after about six to eight hours. Thus, conventional commercial tea brewing and dispensing systems entail a high level of waste, especially in the case of sweet tea which has to be discarded, since sweet tea is particularly expensive due to the cost of the sweetener.

When the diluted tea in a tea urn is discarded due to unacceptable quality, or when the tea urn is emptied by customers, an employee of the convenience store must brew a fresh batch of tea by placing a fresh tea bag in the brew station and initiating the brewing process. However, the employee may not immediately notice the need to brew a fresh batch of tea or may be busy doing other work. As a result, fresh batches of tea may not be brewed on time.

Finally, tea urns should be cleaned daily. Conventional commercial tea brewing and dispensing systems entail a manual cleaning process that requires an employee of the convenience store to remove each of several tea urns (as many as twelve or even more), take each tea urn to a cleaning area, scrub it, rinse it, and then return it to its location. This cleaning process is time-consuming, tedious, and sometimes does not get done, which results in a degradation in the quality of the diluted tea due to a dirty tea urn.

Accordingly, there is a need for an improved commercial tea brewing and dispensing system which overcomes the problems identified above.

### SUMMARY OF THE INVENTION

In accordance with an exemplary embodiment of the present invention, a method for brewing a beverage comprises the steps of brewing a concentrate of the beverage using hot water; reducing a temperature of the beverage concentrate from a first temperature to a predetermined second temperature upon the brewing of the concentrate; and further reducing the temperature of the beverage concentrate from the predetermined second temperature to a third temperature.

In embodiments, the step of reducing the temperature of the beverage concentrate from the first temperature to the predetermined second temperature comprises transferring heat from the beverage concentrate to tap water using a heat exchanger.

In embodiments, the step of further reducing the temperature of the beverage concentrate from the predetermined second temperature to the third temperature comprises refrigerating the beverage concentrate.

In embodiments, the temperature of the beverage concentrate is reduced from the predetermined second temperature to the third temperature within about 4 hours.

In embodiments, the first temperature is about 200° F.

In embodiments, the second temperature is about 70° F.

In embodiments, the third temperature is about 40° F.

In embodiments, a microbial growth in the beverage concentrate is below a predetermined range of microbial growth when the beverage concentrate is at the predetermined second temperature upon the brewing of the concentrate.

In embodiments, the microbial growth is further reduced below the predetermined range when the beverage concentrate is at the third temperature.

In embodiments, the method comprises the steps of detecting when an additional amount of the beverage concentrate should be brewed and brewing the additional amount of the beverage concentrate without additional human intervention.

In embodiments, the method comprises mixing the concentrate of the brewed beverage with hot water to produce a diluted brewed beverage that is substantially free of a cloudy appearance. In embodiments, the mixing step further comprises mixing the concentrate of the brewed beverage with tap water or chilled water.

In accordance with an exemplary embodiment of the present invention, an apparatus for brewing a beverage comprises a brew station configured to brew a beverage concentrate using hot water; a heat exchanger configured to cool the beverage concentrate from a first temperature to a predetermined second temperature; and a storage receptacle in fluid communication with the heat exchanger to hold the beverage concentrate received from an output of the heat exchanger, wherein the temperature of the beverage concentrate is further cooled from the second temperature to the third temperature while the beverage concentrate is held in the storage receptacle.

In embodiments, the apparatus further comprises a refrigerator, wherein the storage receptacle is located within the refrigerator.

In embodiments, the brew station comprises a source of hot water for brewing the beverage concentrate; and a brew basket configured to hold a beverage base that is used to brew the beverage concentrate, wherein hot water is poured over the beverage base from the source of hot water to brew the beverage concentrate and the brew basket is in fluid communication with the storage receptacle to provide the beverage concentrate to the storage receptacle.

In embodiments, the apparatus further comprises a rotating tray, wherein the brew basket is one of a plurality of brew baskets included in the rotating tray.

In embodiments, each one of the plurality of storage receptacles comprises a sensor which detects when an amount of beverage concentrate held in the storage receptacle is at or below a predetermined level.

In embodiments, the sensor comprises a load cell, a resistive probe, an optical sensor, or a float switch.

In embodiments, when it is determined that an amount of the beverage concentrate held in one of the plurality of storage receptacles is at or below a predetermined level, the rotating tray is caused to rotate so that the brew basket of the rotating tray that corresponds to the storage receptacle whose amount of beverage concentrate is at or below the predetermined level is positioned at the brewing station and to brew the beverage concentrate.

In embodiments, the apparatus further comprises a source of hot water; a source of tap water or chilled water; and a mixing vessel in fluid communication with the source of hot water, the source of tap water or chilled water, and the storage receptacle, wherein the beverage concentrate held in the storage receptacle is mixed with hot water provided by the source of hot water and tap water or chilled water that is provided by the source of tap water or chilled water.

In embodiments, the apparatus further comprises one or more sources of flavorings in fluid communication with the mixing vessel to supply a predetermined amount of one or more flavorings to the mixing vessel.

In embodiments, the apparatus further comprises a source of a sweetener in fluid communication with the mixing vessel to supply a predetermined amount of the sweetener to the mixing vessel.

In accordance with an exemplary embodiment of the present invention, an apparatus for brewing a beverage comprises a brew basket configured to hold a cleaning aid; a source of hot water, wherein hot water from the source of hot water is introduced into the brew basket and comes into contact with the cleaning aid to produce a cleaning solution; a storage receptacle in fluid communication with the brew basket to receive the cleaning solution from the brew basket; a reservoir in fluid communication with the storage receptacle to receive the cleaning solution from the brew basket; and a pump that recirculates the cleaning solution between the reservoir and the storage receptacle for a predetermined period of time.

In embodiments, the storage receptacle comprises a dedicated cleaning nozzle through which the cleaning solution enters the storage receptacle.

In embodiments, the dedicated cleaning nozzle is a spray nozzle.

In embodiments, the storage receptacle comprises a valve through which the cleaning solution exits the storage receptacle.

In embodiments, the apparatus further comprises a dispensing nozzle for dispensing the beverage; a mixing vessel in fluid communication with the storage receptacle and the dispensing nozzle; and a pump that moves a portion of the cleaning solution from the storage receptacle to the dispensing nozzle through the mixing vessel.

In embodiments, the pump that moves the portion of the cleaning solution from the storage receptacle to the dispensing nozzle through the mixing vessel comprises a peristaltic pump.

In embodiments, the apparatus further comprises a plurality of brew baskets; and a plurality of storage receptacles; wherein: each one of the plurality of brew baskets is in fluid communication with any one of the plurality of storage receptacles; and the pump recirculates the cleaning solution between the reservoir and each one of the plurality of storage receptacles for a predetermined period of time.

In embodiments, the apparatus further comprises a plurality of brew baskets; and a plurality of storage receptacles; wherein: each one of the plurality of brew baskets is in fluid communication with any one of the plurality of storage receptacles; and the pump recirculates the cleaning solution between the reservoir and each one of the plurality of storage receptacles in a predetermined sequence.

In embodiments, the apparatus further comprises a drain in fluid communication with the reservoir to receive the contents of the reservoir.

In accordance with an exemplary embodiment of the present invention, a method for cleaning an apparatus used to brew a beverage comprises producing, in a brew basket configured to hold a cleaning aid, a cleaning solution by introducing hot water from a source of hot water into the brew basket so that it comes into contact with the cleaning aid; receiving, in a storage receptacle, the cleaning solution from the brew basket; transferring the cleaning solution from the storage receptacle to a reservoir; and recirculating the cleaning solution between the reservoir and the storage receptacle for a predetermined period of time.

In embodiments, the recirculating step comprises spraying the cleaning solution into the storage receptacle.

In embodiments, the apparatus comprises a dispensing nozzle which is configured to dispense the beverage; and the method further comprises moving a portion of the cleaning solution from the storage receptacle to the dispensing nozzle.

In embodiments, the apparatus comprises a mixing vessel in fluid communication with the storage receptacle and the dispensing nozzle; and the method further comprises moving a portion of the cleaning solution from the storage receptacle to the dispensing nozzle through the mixing vessel.

In embodiments, the moving step is performed after the receiving step and before or during the recirculating step.

In embodiments, the apparatus comprises a plurality of brew baskets and a plurality of storage receptacles, wherein each one of the plurality of brew baskets is in fluid communication with any one of the plurality of storage receptacles; and the method comprises recirculating the cleaning solution between the reservoir and each one of the plurality of storage receptacles for a predetermined period of time.

In embodiments, the apparatus comprises a plurality of brew baskets and a plurality of storage receptacles, wherein each one of the plurality of brew baskets is in fluid communication with any one of the plurality of storage receptacles; and the pump recirculates the cleaning solution between the reservoir and each one of the plurality of storage receptacles in a predetermined sequence.

In embodiments, the transferring step comprises transferring the cleaning solution from two of the plurality of storage receptacles to the reservoir simultaneously; and the recirculating step comprises recirculating the cleaning solution from the reservoir to each of the two of the plurality of storage receptacles in an alternating manner.

In accordance with an exemplary embodiment of the present invention, an apparatus for brewing a beverage comprises a brew station configured to brew a beverage concentrate using hot water; a heat exchanger configured to cool the beverage concentrate from a first temperature to a predetermined second temperature; and a storage receptacle in fluid communication with the heat exchanger to hold the beverage concentrate received from an output of the heat exchanger, wherein the temperature of the beverage concentrate is further cooled from the second temperature to the third temperature while the beverage concentrate is held in the storage receptacle. Upon completion of brewing the beverage concentrate, the apparatus compares an actual level of the beverage concentrate in the storage receptacle to an anticipated level of the beverage concentrate.

In embodiments, the apparatus disables future brews of beverage concentrate if it determines that the actual level of the beverage concentrate in the storage receptacle does not correspond to the anticipated level.

In accordance with an exemplary embodiment of the present invention, an apparatus for brewing a beverage comprises a brew station configured to brew a beverage concentrate using hot water; a heat exchanger configured to cool the beverage concentrate from a first temperature to a predetermined second temperature; and a storage receptacle in fluid communication with the heat exchanger to hold the beverage concentrate received from an output of the heat exchanger, wherein the temperature of the beverage concentrate is further cooled from the second temperature to the third temperature while the beverage concentrate is held in the storage receptacle. The apparatus forecasts and displays estimated times for the next brews of the beverage concentrate.

In embodiments, the apparatus subtracts an average hourly depletion of the beverage concentrate in the storage receptacle from a current weight of the beverage concentrate in the storage receptacle to forecast the estimated times.

In embodiments, the apparatus comprises a plurality of storage receptacles, wherein the apparatus forecasts and displays the estimated times for the next brews of the beverage concentrate for each one of the plurality of storage receptacles.

In embodiments, for each one of the plurality of storage receptacles, the apparatus subtracts an average hourly depletion of the beverage concentrate in the storage receptacle from a current weight of the beverage concentrate in the storage receptacle to forecast the estimated time.

### BRIEF DESCRIPTION OF THE DRAWINGS

The following detailed description, given by way of example and not intended to limit the present invention solely thereto, will best be understood in conjunction with the accompanying drawings in which:

FIG. 1 shows a front view of an apparatus for brewing a beverage in accordance with an exemplary embodiment of the present invention.

FIG. 2 shows an exemplary order entry screen of the apparatus shown in FIG. 1.

FIG. 2A shows an exemplary service screen of the apparatus shown in FIG. 1.

FIG. 3 shows a right-side view of a portion of the apparatus shown in FIG. 1.

FIG. 4 shows a top view of the apparatus shown in FIG. 1.

FIG. 5 is a plumbing diagram of an apparatus for brewing a beverage in accordance with an exemplary embodiment of the present invention.

FIG. 6 shows a graph of the temperature of a tea concentrate as a function of time in accordance with an exemplary embodiment of the present invention.

FIG. 7 shows a block diagram of connections between a master controller and various components in an apparatus for brewing a beverage in accordance with an exemplary embodiment of the present invention.

FIG. 8 shows a self-cleaning system for an apparatus for brewing a beverage in accordance with an exemplary embodiment of the present invention.

FIG. 9 shows a front view of an apparatus for brewing a beverage in accordance with another exemplary embodiment of the present invention.

FIG. 10 shows a front view of an apparatus for brewing a beverage in accordance with yet another exemplary embodiment of the present invention.

### DETAILED DESCRIPTION OF EXEMPLARY EMBODIMENTS

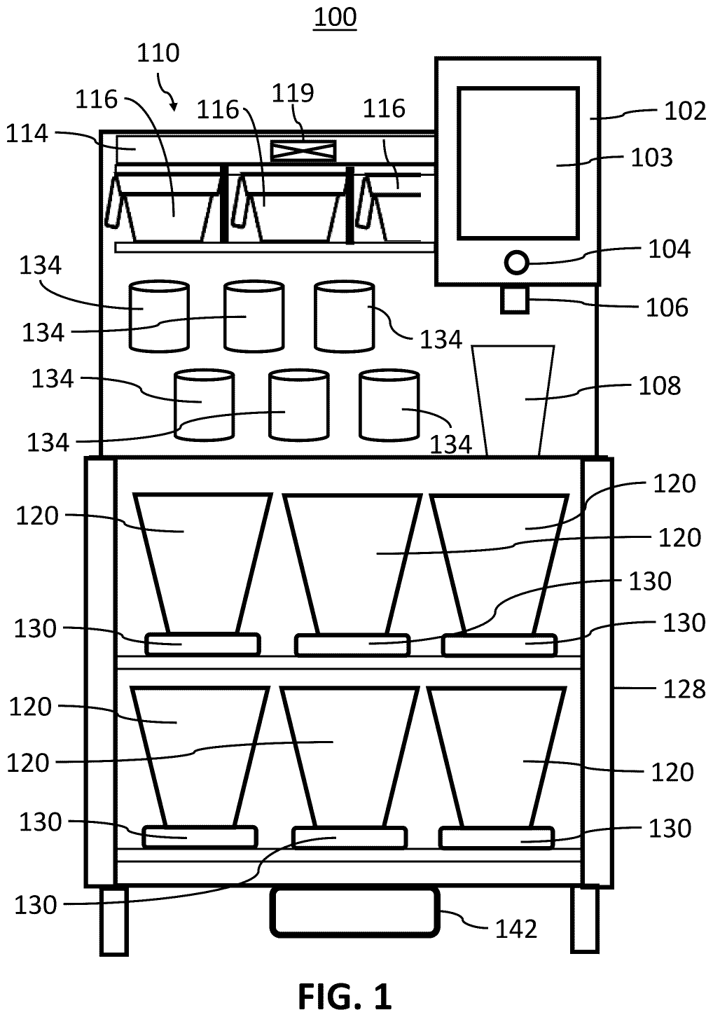

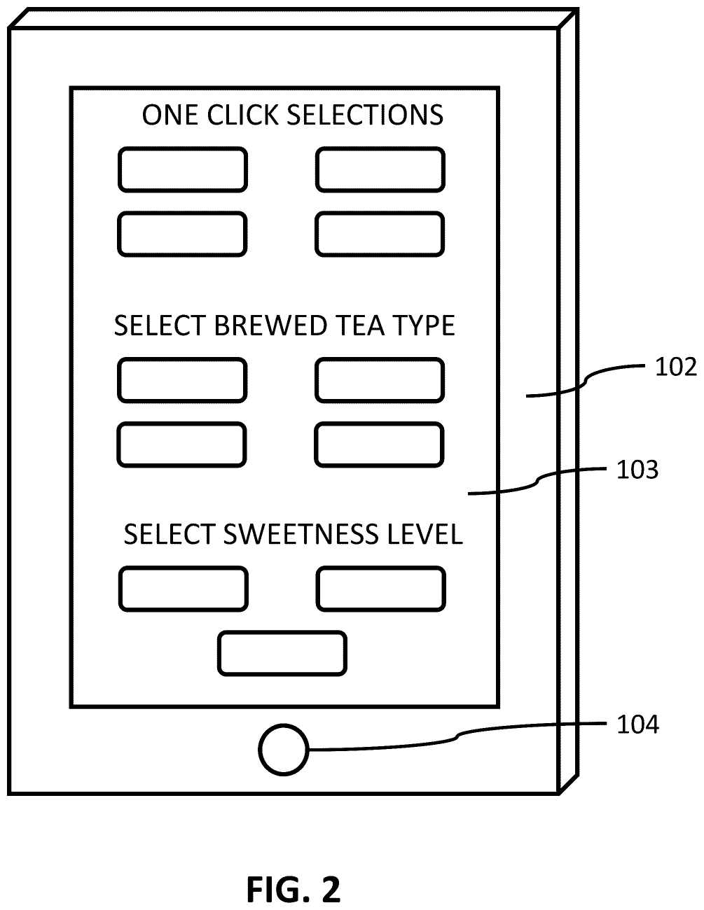

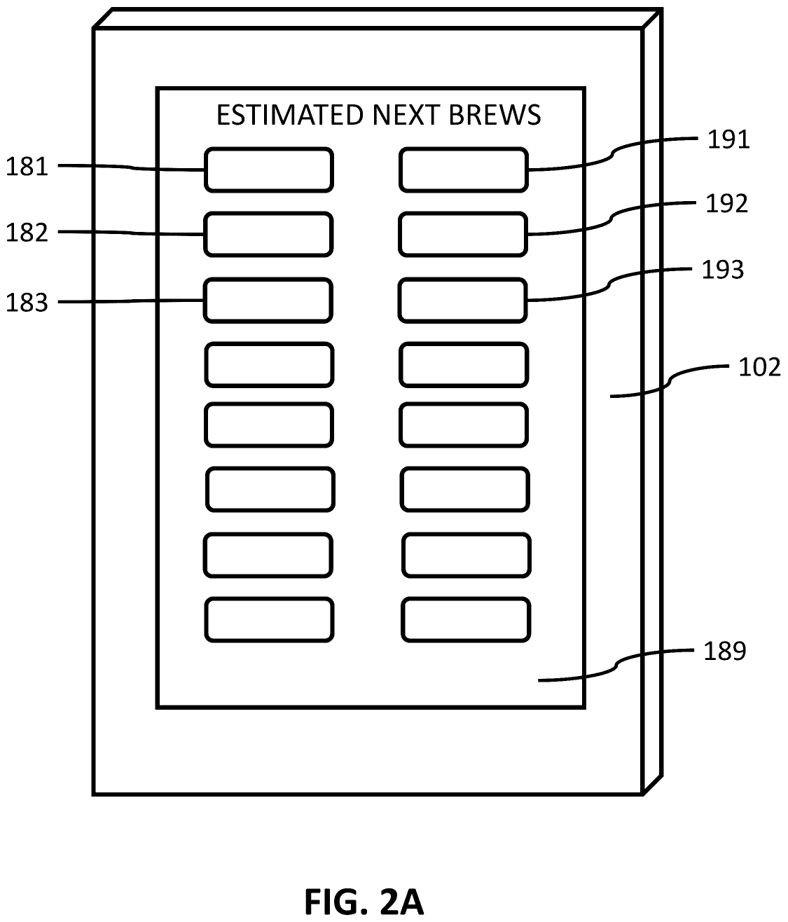

In the present disclosure, like reference numbers refer to like elements throughout the drawings, which illustrate various exemplary embodiments of the present invention. Referring now to the drawings and in particular to FIG. 1, there is depicted a front view of an exemplary embodiment of an apparatus 100 for brewing and dispensing tea to a customer in accordance with the present invention. Apparatus 100 includes a display 102 which displays an order entry screen 103 where a customer can order a customized tea beverage. One example of an order entry screen 103 in accordance with embodiments of the present invention is shown in FIG. 2. As shown in FIG. 2, the customer selects a type of brewed tea displayed on order entry screen 103 and also selects a sweetness level for the tea beverage. Although not shown in FIG. 2, other exemplary order entry screens 103 allow the customer to select other additives (e.g., flavorings or particular types of sweeteners) that are to be added to the tea. Commonly preferred combinations of teas, sweeteners, and flavorings can be offered together as “One Click Selections” as depicted on display 102 in FIG. 2. In a presently preferred embodiment, display 102 is implemented using a touch-screen display, but it can also be implemented using any other suitable means.

Once the tea beverage has been ordered using order entry screen 103, the customer can press a button 104 to dispense the tea beverage through a delivery nozzle 106 into a cup 108 which the customer has placed beneath delivery nozzle 106. In a presently preferred embodiment, the apparatus 100 can include one or more cup dispensers from which the customer can take a cup having a desired size and an ice dispenser from which the customer can add a desired amount of ice to his cup. (The one or more cup dispensers and the ice dispenser are not shown in FIG. 1.)

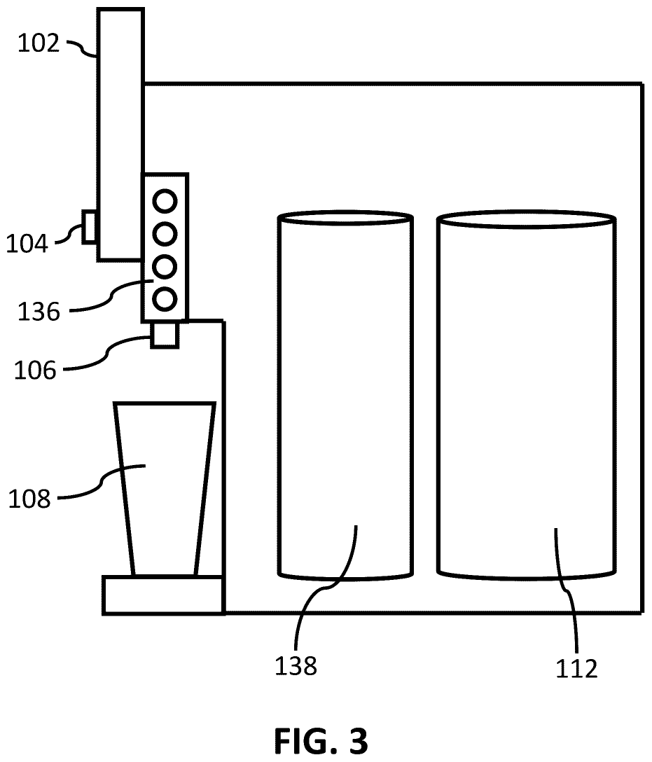

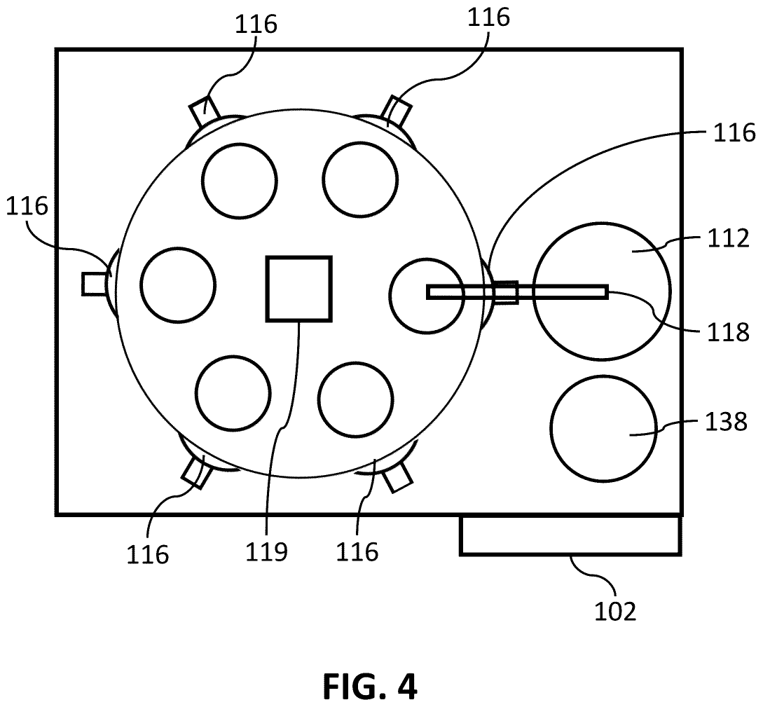

Apparatus 100 further includes a brew station 110 for brewing the types of tea that are dispensed by apparatus 100. Specifically, the brew station 110 brews a tea concentrate for each one of the types of tea that are currently being dispensed by apparatus 100. As shown in FIGS. 1 and 3, the brew station 110 includes a brew hot water tank 112 that provides a source of hot water for brewing the tea concentrates. Brew station 110 further includes a rotating tray 114 which has a plurality of brew baskets 116 located thereon. Each of the brew baskets 116 is configured to hold a tea bag (i.e., a “tea base”) for one of the types of tea that are currently being dispensed by apparatus 100. As shown in FIG. 4, rotating tray 114 has six brew baskets 116, since apparatus 100 is configured to brew six types of brewed tea. In alternative embodiments, the number of brew baskets 116 is not necessarily equal to the number of types of tea that apparatus 100 may be configured to offer. Specifically, the number of brew baskets 116 can be greater than the number of types of tea that apparatus 100 is configured to offer.

To brew each one of the tea concentrates, a tea bag (not shown) for a particular type of tea is placed into a brew basket 116 and hot water from brew hot water tank 112 is poured into the brew basket 116 and comes in contact with the tea bag to brew the tea concentrate. As shown in FIG. 4, the hot water flows from brew hot water tank 112 into brew basket 116 through a hot water conduit 118.

In an embodiment of apparatus 100, rotating tray 114 includes one or more fans 119 located on a top portion thereof, above the brew baskets 116, as shown in FIGS. 1 and 3. The one or more fans 119 push the aromas of the tea bags and/or brewing teas from the brew baskets 116 to the front of the apparatus 100.

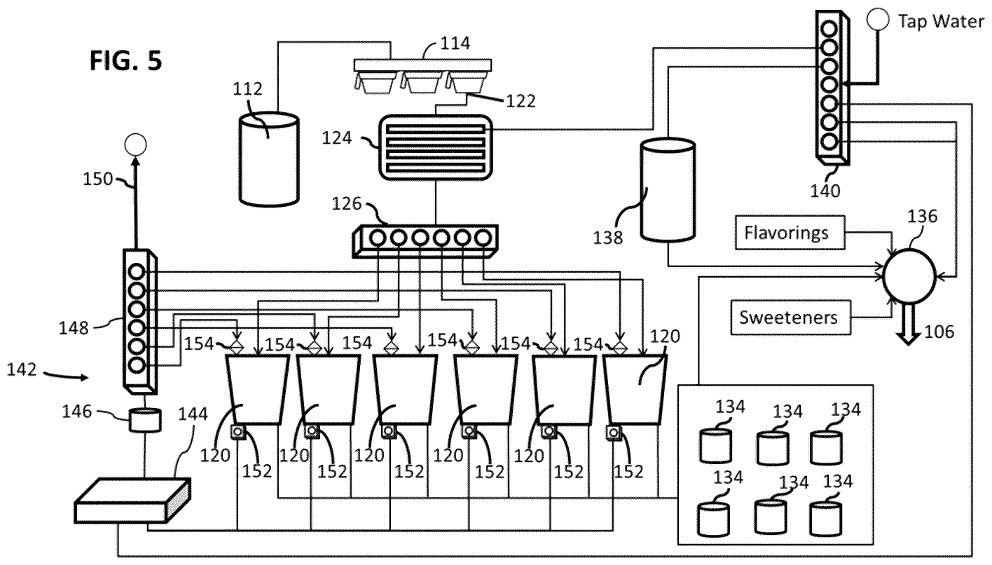

Referring now to FIGS. 1 and 5, each of the brew baskets 116 can be in fluid communication with any one of storage receptacles 120, which receive and hold the tea concentrate that is brewed in the brew baskets 116. (This is useful because teas having higher sales volumes will need more brew cycles to keep up. Thus, it is convenient for multiple brew baskets 116 to be in fluid communication with a single storage receptacle 120 to increase the restock interval of the tea.) Of course, each of the brew baskets 116 is in fluid communication with only one of the storage receptacles 120 at a time through fluid diverter 126.

The freshly brewed, hot tea concentrate exits brew basket 116 through an exit nozzle 122 at a temperature of about 200° F. and proceeds to a heat exchanger 124, where the hot tea concentrate is immediately cooled to a temperature of about 70° F. In an embodiment of apparatus 100, the heat exchanger 124 is a counter-flow heat exchanger, but heat exchanger 124 can also be implemented using any other suitable means. As discussed above, in connection with conventional tea brewing and delivery systems, the temperature of the tea dispensed to a customer will vary between about 100° F. and about 80° F. depending on when the tea was brewed. There is a range of microbial growth occurring in the tea within this temperature range. (The actual bounds of the microbial growth curve in the tea within this temperature range may vary to some degree depending on the microbe.) Thus, in a conventional tea brewing and delivery process, the microbial growth in the tea is always in a predetermined range that is determined by the temperature range of the tea and the nature of the microbe. In contrast, in apparatus 100, by immediately cooling the freshly brewed, hot tea concentrate from about 200° F. to about 70° F. upon the brewing of the concentrate, the microbial growth in the tea is significantly reduced below the predetermined range from the outset.

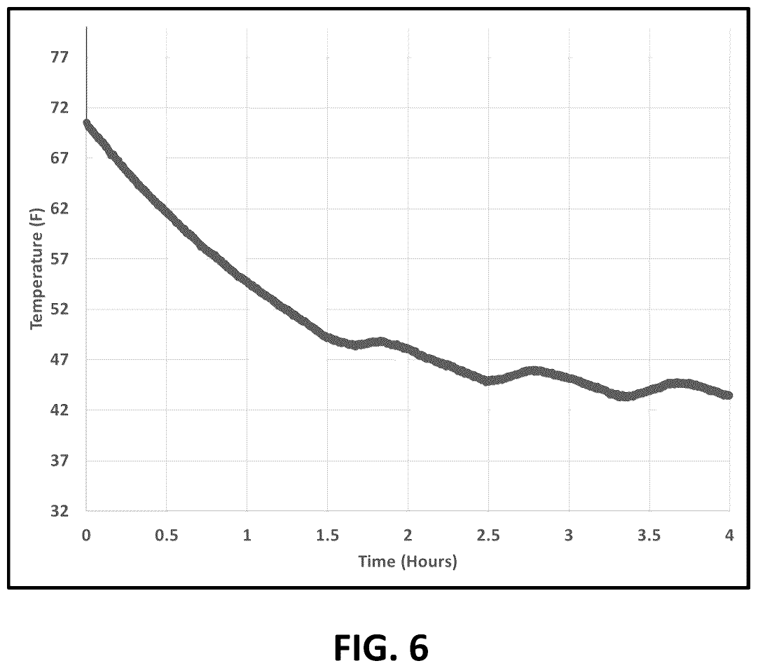

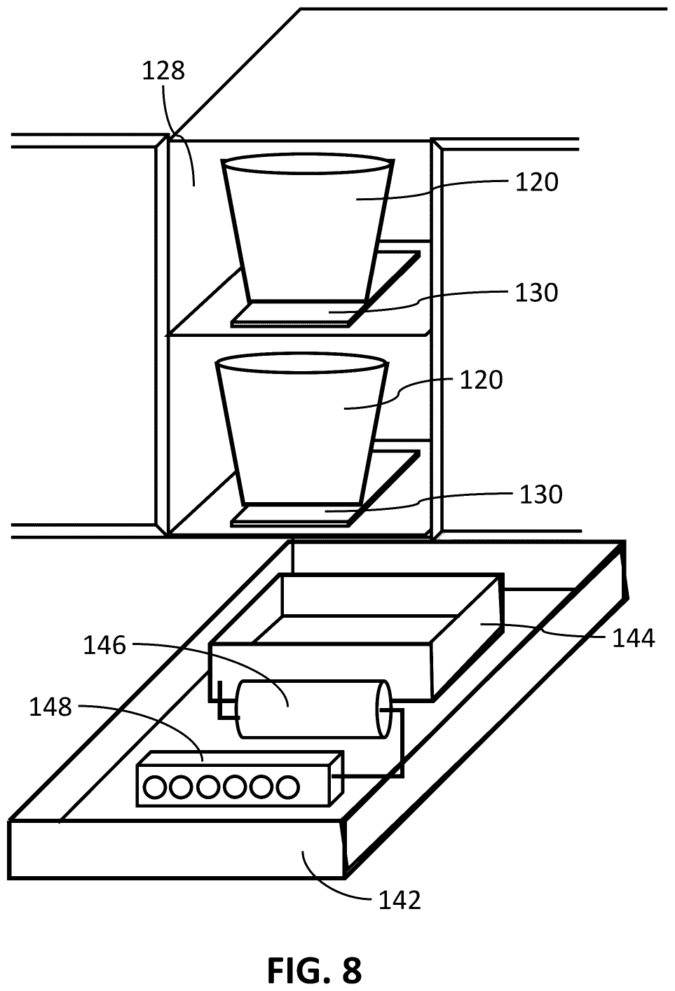

Referring again to FIGS. 1 and 5, the cooled tea concentrate exits the heat exchanger 124 and is directed to the appropriate storage receptacle 120 by fluid diverter 126. As shown in FIGS. 1 and 8, the storage receptacles 120 are located in a refrigerator 128 so that the cooled tea concentrate is further cooled while being held in the storage receptacle 120. As shown in FIG. 6, the tea concentrate has a temperature of about 70° F. when it enters the storage receptacle 120 (at Time=0). Within about ninety minutes after entering the storage receptacle 120 the tea concentrate reaches a temperature of about 50° F. The tea concentrate eventually reaches a temperature of about 40° F. within about four hours after entering the storage receptacle 120. Thus, the microbial growth in the tea concentrate is further reduced within about 90 minutes after entering the storage receptacle 120. After another about two and a half hours, the tea concentrate reaches a temperature of about 40° F. and thus the microbial growth is still further reduced. As a result of the immediate cooling of the freshly brewed tea concentrate in heat exchanger 124 and the subsequent cooling of the tea concentrate in the refrigerated storage receptacles 120, the tea concentrate does not have to be discarded after about eight hours but can remain in the storage receptacles 120 for about one week or longer without experiencing a degradation in its quality.

As shown in FIG. 1, in one embodiment refrigerator 128 holds six storage receptacles 120, if the apparatus 100 is configured to brew six types of brewed tea. In alternative embodiments, depending on the preferences of food-service operators, apparatus 100 may be configured to offer fewer or more than six types of brewed tea, in which case refrigerator 128 would hold a corresponding number of storage receptacles 120. In embodiments, each storage receptacle 120 includes a stirring motor and mechanism (not shown) which stirs the tea concentrate periodically while it is being held in the storage receptacle 120.

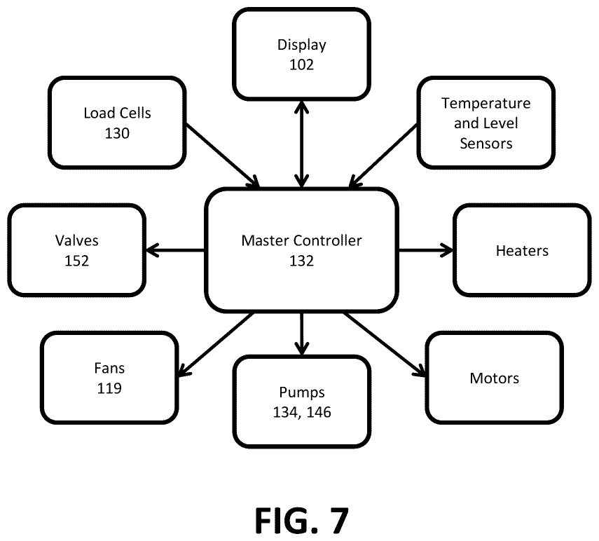

Each of the storage receptacles 120 has an associated sensor which is used to facilitate automated brewing of tea concentrate in apparatus 100. As shown in FIG. 1, each storage receptacle 120 sits on a dedicated load cell 130 in the refrigerator 128. As shown in FIG. 7, the load cells 130 are monitored by a master controller 132 of apparatus 100. When the weight of the tea concentrate in the storage receptacle 120 reaches or drops below a certain predetermined weight, the master controller 132 determines that the tea concentrate in the storage receptacle 120 must be replenished. In alternative embodiments, the levels of tea concentrate remaining in the storage receptacles 120 can be sensed by other types of sensors rather than by load cells. Such other types of sensors include resistive probes, optical sensors, and float switches (such as reed switch floats). Each of these types of level sensors would also be monitored by master controller 132.

The master controller 132 then initiates automated brewing of the type of tea that must be brewed. Specifically, master controller 132 causes a motor (not shown) to rotate the rotating tray 114 such that the brew basket 116 containing a tea bag with the type of tea that must be brewed is in position to receive hot water from brew hot water tank 112 through hot water conduit 118. Master controller 132 then causes the brew hot water tank 112 to provide hot water to brew basket 116 through hot water conduit 118 to brew the tea. Finally, master controller 132 also causes the fluid diverter 126 to rotate to the proper position to direct the tea concentrate to the appropriate storage receptacle 120 after it exits the heat exchanger 124.

In a preferred embodiment, apparatus 100 informs the operator of which particular types of tea bags should be placed in brew baskets 116 to minimize the number of visits the operator must make to apparatus 100 each day for the purpose of replacing tea bags. As shown in FIG. 7, load cells 130 are monitored by master controller 132 of apparatus 100. Each hour the measured weight of the tea concentrate in each of the storage receptacles 120 is stored in master controller 132, and the average hourly depletion (i.e., the hour-by-hour average change in the measured weight of the tea concentrate) since the last brew of each tea concentrate is calculated and stored in master controller 132. In a presently preferred embodiment, a seven-day rolling average of the hourly depletion of tea concentrate in each storage receptacle 120 is stored in master controller 132.

The average hourly depletion of tea concentrate is used to forecast the estimated times when the next several brews for each particular type of tea concentrate that is being brewed by apparatus 100 will need to occur. This forecast is generated by master controller 132 of apparatus 100 when an operator accesses a service screen 189 of apparatus 100. (Service screen 189 is shown in FIG. 2A and is described below.) For each particular type of tea concentrate that is being brewed by apparatus 100, when the operator accesses service screen 189 the average hourly depletion of the tea concentrate is subtracted from the current weight (i.e., the current level) of the tea concentrate in its storage receptacle 120. If the resulting value for a particular type of tea concentrate is less than the predetermined threshold weight that is used to determine when that particular type of tea concentrate must be replenished, then the current hour is recorded for the “next” brew for that particular type of tea concentrate and a “brew delta” is added to the resulting value. (The “brew delta” for a particular type of tea concentrate is the expected weight increase in its storage receptacle 120 from the addition of brewed tea concentrate.) Otherwise, this process is repeated for the following hour. In a presently preferred embodiment, this process continues to be repeated until the times for three “next” brews are estimated for each particular type of tea concentrate that is being brewed by apparatus 100, or until a period of 168 hours (i.e., seven days) has been iterated through.

Referring now to FIG. 2A, service screen 189 on display 102 of apparatus 100 shows the operator which tea types are the next ones to be brewed and the corresponding estimated times until those brews will be required. As shown in FIG. 2A, an exemplary service screen 189 shows the next tea type to be brewed 181 and the estimated time until that brew is required 191; the second next tea type to be brewed 182 and the estimated time until that brew is required 192; the third next tea type to be brewed 183 and the estimated time until that brew is required 193; and so on. When the operator accesses service screen 189 of apparatus 100, the information provided on service screen 189 advantageously enables the operator to place into brew baskets 116 the particular tea bags that are most likely to be needed. This minimizes the number of visits the operator must make to apparatus 100 each day for the purpose of replacing tea bags.

In another preferred embodiment, once master controller 132 determines that the tea concentrate in a storage receptacle 120 must be replenished, the measured level of tea concentrate that caused master controller 132 to initiate brewing is stored in master controller 132. Upon completion of the brewing process, the actual level of the tea concentrate in the storage receptacle 120 is again sensed, and that actual level is compared by master controller 132 to an anticipated level of tea concentrate based on the volume of water that master controller 132 caused to be delivered from brew hot water tank 112 to brew basket 116 to brew the tea. If the actual level of tea concentrate in the storage receptacle 120 after completion of the brewing process does not correspond to the anticipated level, then this result indicates an error condition during the brew process, and master controller 132 disables future brews until a service function is performed on apparatus 100.

As described above with reference to FIGS. 1 and 2, once the tea beverage has been ordered using the order entry screen 103, the customer can press the button 104 to dispense the tea beverage through the delivery nozzle 106 into the cup 108. Referring now to FIG. 5, when the customer presses the button 104, the tea concentrate for the tea selected by the customer is pumped from its storage receptacle 120 by a pump 134 which corresponds to that storage receptacle 120. In a presently preferred embodiment, the pumps 134 are peristaltic pumps, but the pumps 134 can also be implemented using any other suitable means.

The pump 134 pumps the tea concentrate to a tea serving manifold 136 which serves as a mixing vessel where the tea concentrate is mixed with hot water from a dispense hot water tank 138 and with tap water from a tap water manifold 140 to provide a diluted tea beverage which is further mixed with any sweeteners and/or flavorings before being dispensed to the customer. In preferred embodiments, the tap water from tap water manifold 140 is first chilled to a temperature below the temperature of the water supplied to tap water manifold 140 and the chilled water is mixed with the tea concentrate and the hot water from dispense hot water tank 138 in the tea serving manifold 136. If possible, the use of chilled water is preferable so that the dispensed tea beverage will have a lower temperature and thereby will melt less ice in a cup 108. As also shown in FIG. 5, any sweeteners and/or flavorings that the customer selected to include in its tea beverage are mixed with the diluted tea beverage in the tea serving manifold 136, prior to the dispensing of the completed tea beverage through delivery nozzle 106.

In embodiments, the temperature of the hot water provided by dispense hot water tank 138 is about 200° F. and the tea concentrate, hot water, and tap water (or chilled water) are mixed in the tea serving manifold 136 in accordance with the following mixing ratio: about one part tea concentrate to about two parts hot water to about three parts tap water (or chilled water). It has been found that the ratio of hot water to tea concentrate is dependent upon the temperature of the hot water. Specifically, for a hot water temperature that is in the range of about 180° F. to about 200° F., the use of about two parts hot water in the mixing ratio eliminates a cloudy appearance of the diluted tea beverage that occurs when about one part tea concentrate is mixed with about five parts tap water (or chilled water). It has also been found that a mixing ratio of about one part tea concentrate to about one part hot water to about four parts tap water (or chilled water) will also eliminate a cloudy appearance of the diluted tea beverage if the hot water is at a boiling temperature (i.e., about 212° F.). In embodiments, the cloudy appearance of the diluted tea beverage can also be eliminated using a mixing ratio of about one part tea concentrate to about five parts tap water (or chilled water) if the tea concentrate is heated at some point between the refrigerated storage receptacle 120 and the tea serving manifold 136 to a temperature that eliminates the cloudiness. Such heating can be provided by pumping the tea concentrate through a heat exchanger or by microwaving the tea concentrate.

In alternative embodiments, the amount of tap water (or chilled water) in the above mixing ratio may vary depending on the sweetener level, the flavorings, and the concentration of the tea concentrate for the tea beverage that the customer has ordered. For example, if the tea beverage being dispensed by the apparatus 100 includes a sweetener, the sweetener also dilutes the tea beverage. Accordingly, if the tea beverage includes a liquid sweetener (and, potentially, flavorings), the amount of tap water (or chilled water) will be reduced (i.e., will be less than about three parts for every part of the tea concentrate) to keep the tea concentration of the tea beverage roughly constant. In general, the volume of tap water (or chilled water) will be reduced by an amount that is about equal to the volume of any liquid sweetener and any liquid flavorings that are being added to the tea beverage. However, the settings of the apparatus 100 can be fine-tuned to control the amount of tap water (or chilled water) and the amount of tea concentrate provided to the tea serving manifold 136 for each sweetness level available for the tea beverage.

In an alternative embodiment, apparatus 100 is configured to also dispense a hot tea beverage. In that case, the amount of tap water (or chilled water) that is mixed with the tea concentrate and the hot water in tea serving manifold 136 may be significantly reduced or even eliminated. For instance, hot tea may be dispensed at a mixing ratio of one part tea concentrate to five parts hot water. In embodiments, the settings of apparatus 100 can be adjusted to customize the dispense temperature of the hot tea. In that case, some of the hot water will be substituted with an amount of tap water (or chilled water) sufficient to provide the desired dispense temperature for the hot tea.

FIG. 7 provides a schematic diagram of the connections between master controller 132 of apparatus 100 and various components of the apparatus 100, including display 102, fans 119, load cells 130, pumps 134, 146, valves 152, temperature and level sensors (not shown), heaters (not shown), and various motors (not shown). As indicated by the directions of the arrows in FIG. 6, communication between master controller 132 and display 102 is bidirectional. Master controller 132 receives input from load cells 130 and from the temperature and level sensors. Master controller 132 provides output to the heaters, the stirring motors of the storage receptacles 120, pumps 134, 146, fans 119, and valves 152.

In a presently preferred embodiment, apparatus 100 includes a self-cleaning system 142. Referring to FIGS. 1, 5, and 8, self-cleaning system 142 includes a reservoir 144, a self-clean pump 146, and a self-clean manifold 148. In operation, the self-cleaning process is initiated by pressing a “Clean” button on a system screen which is displayed on display 102. The master controller 132 then causes the display 102 to prompt the employee of the convenience store to place a cleaning aid, such as a cleaning tablet, into one or more of the brew baskets 116. It should be noted that, in preferred embodiments, the cleaning tablet fully dissolves in the brew basket 116 so that there is nothing that needs to be removed from the brew basket 116, as would be the case if a “tea bag like” cleaner bag were used. In that case, the bag would need to be removed from the brew basket 116 once the cleaning aid in the bag is dissolved.

Before the master controller 132 causes apparatus 100 to run hot water over the cleaning tablet in a brew basket 116, the tea concentrate present in each of the storage receptacles 120 is vacated from the storage receptacles 120. The master controller 132 causes a drain valve 152 in the storage receptacle 120 to open and the tea concentrate present in the storage receptacle 120 is drained by gravity into the reservoir 144. In embodiments, two of the storage receptacles 120 are vacated simultaneously. The self-clean pump 146 pumps the tea concentrate from the reservoir 144 to the drain 150 of the apparatus 100.

When the tea concentrate is vacated from the storage receptacle 120 into the reservoir 144, the master controller 132 causes the pump 134 corresponding to the storage receptacle 120 to engage, thereby moving air through the line (e.g., tubing) that runs from the storage receptacle 120 to the delivery nozzle 106, which clears any tea concentrate that is present in that line.

Hot water from the brew hot water tank 112 then runs over the cleaning tablet in the brew basket 116 to dissolve the cleaning tablet and thereby produce a cleaning solution. This cleaning solution exits brew basket 116 through exit nozzle 122 and proceeds to the storage receptacle 120 through the heat exchanger 124 and fluid diverter 126, as if tea were being brewed. However, during the self-cleaning process, the heat exchange functionality of heat exchanger 124 is not engaged. For instance, if heat exchanger 124 is implemented using a counter-flow heat exchanger, tap water is not flowing in the opposite direction of the hot cleaning solution, unlike during the tea brewing process, because the cleaning solution functions best when it is hotter.

Once the cleaning solution is in the storage receptacle 120, it remains there for about three to nine minutes, after which time the master controller 132 causes a drain valve 152 in storage receptacle 120 to open, thereby draining the cleaning solution from the storage receptacle 120 into the reservoir 144. When the cleaning solution has drained into the reservoir 144, the self-clean pump 146 recirculates the cleaning solution between the reservoir 144 and the storage receptacle 120 through a valve in the self-clean manifold 148. The recirculated cleaning solution enters the storage receptacle 120 through a dedicated cleaning nozzle 154 which is in fluid communication with the valve in the self-clean manifold 148. In a presently preferred embodiment, the dedicated cleaning nozzle 154 is a spray nozzle and the cleaning solution is sprayed into the storage receptacle 120 for a predetermined period of time. After being sprayed into the storage receptacle 120, the cleaning solution returns to the reservoir 144 through the drain valve 152 in the storage receptacle 120. This recirculation of the cleaning solution between the storage receptacle 120 and the reservoir 144 is performed for a predetermined period of time.

In a presently preferred embodiment, the cleaning solution from two of the storage receptacles 120 is drained into reservoir 144 simultaneously. The cleaning solution is then recirculated between the reservoir 144 and one of the storage receptacles 120 for a predetermined period of time, for example fifteen seconds. Next, the cleaning solution is recirculated between the reservoir 144 and the other one of the storage receptacles 120 for the same predetermined period of time (e.g., fifteen seconds). The recirculation of the cleaning solution from the reservoir 144 then alternates between each of the two storage receptacles 120 in the manner described above for a predetermined period of time. In a preferred embodiment, the recirculation of the cleaning solution from the reservoir 144 alternates between each of the two storage receptacles 120 for a period of about nine minutes. At the completion of the recirculation process for each storage receptacle 120, the cleaning solution from each storage receptacle 120 is drained through drain valve 152 to reservoir 144 and the self-clean pump 146 pumps the contents of reservoir 144 to the drain 150 of the apparatus 100.

In a presently preferred embodiment, a portion of the cleaning solution held in a storage receptacle 120 is pumped from the storage receptacle 120 by its corresponding pump 134 through the line (e.g., tubing) that runs from the storage receptacle 120 to the tea serving manifold 136 and the line (e.g., tubing) that runs from the tea serving manifold 136 to the delivery nozzle 106, thereby cleaning those lines. The cleaning solution is pumped from the storage receptacle 120 to the delivery nozzle 106, through the tea serving manifold 136, after the cleaning solution is brewed into the storage receptacle 120 but before or during the recirculation of the cleaning solution between the reservoir 144 and the storage receptacle 120.

After the recirculation process has been completed for each storage receptacle 120 as described above, the storage receptacle 120 is rinsed with hot water. In a presently preferred embodiment, master controller 132 causes the dispense hot water tank 138 to supply hot water to reservoir 144 and self-clean pump 146 pumps the hot water to the dedicated cleaning nozzle 154 of the storage receptacle 120 through a valve of the self-clean manifold 148. The hot water is sprayed into storage receptacle 120 to rinse it with hot water. A portion of the hot water from the storage receptacle 120 is also pumped from the storage receptacle 120 by its corresponding pump 134 through the line (e.g., tubing) that runs from the storage receptacle 120 to the tea serving manifold 136 and the line (e.g., tubing) that runs from the tea serving manifold 136 to the delivery nozzle 106, thereby rinsing those lines with hot water.

After each storage receptacle 120 has been rinsed with hot water, it is finally rinsed with tap water. In a presently preferred embodiment, master controller 132 causes a tap water manifold 140 to supply tap water to reservoir 144 and self-clean pump 146 pumps the tap water to the dedicated cleaning nozzle 154 of the storage receptacle 120 through a valve of the self-clean manifold 148. The tap water is sprayed into storage receptacle 120 to rinse it with tap water. A portion of the tap water from storage receptacle 120 is also pumped from the storage receptacle 120 by its corresponding pump 134 through the line (e.g., tubing) that runs from the storage receptacle 120 to the tea serving manifold 136 and the line (e.g., tubing) that runs from the tea serving manifold 136 to the delivery nozzle 106, thereby rinsing those lines with tap water.

Master controller 132 can be programmed to cause the self-cleaning system 142 to recirculate the cleaning solution between the reservoir 144 and the storage receptacles 120 in any predetermined sequence. In addition, as described above, in a preferred embodiment the cleaning solution from two of the storage receptacles 120 is drained into reservoir 144 simultaneously and the recirculation of the cleaning solution from the reservoir 144 then alternates between the two storage receptacles 120. Any two of the storage receptacles 120 can be grouped together for this purpose.

In a presently preferred embodiment, apparatus 100 has a width dimension of no more than about four feet. Thus, apparatus 100 occupies only a small amount of space.

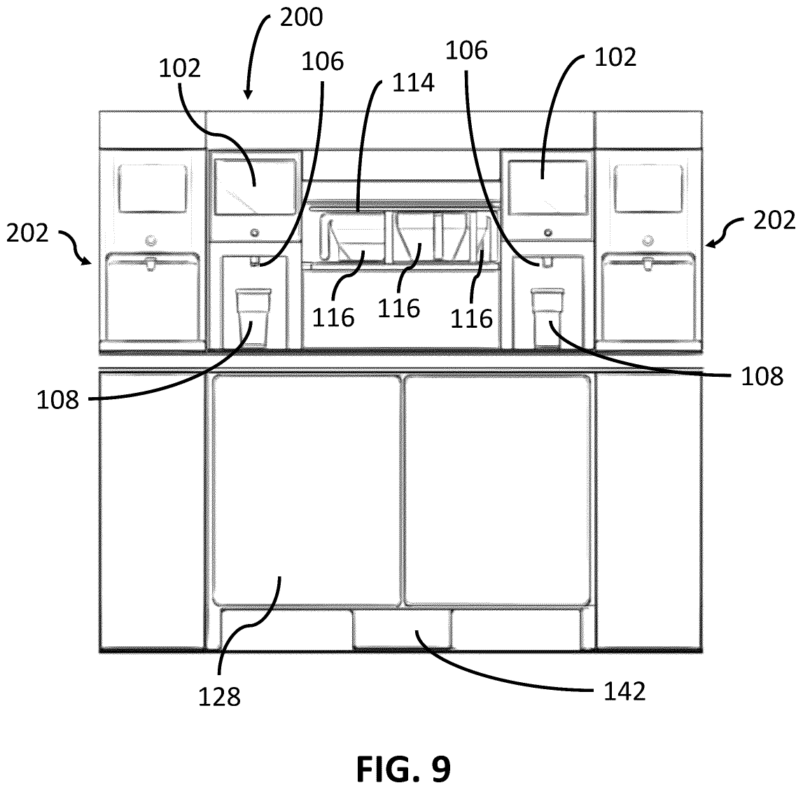

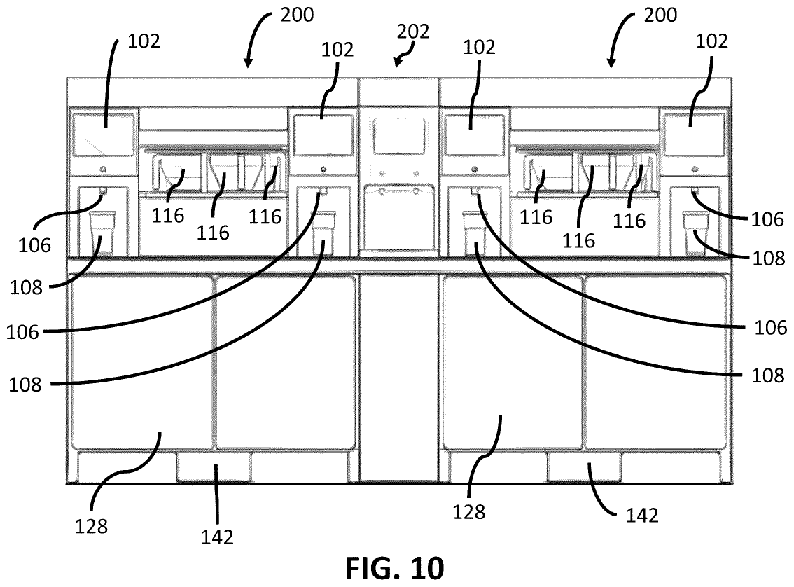

FIG. 9 shows an apparatus 200 which differs from apparatus 100 only in that apparatus 200 includes two displays 102 (for displaying two order entry screens) and two delivery nozzles 106 (for dispensing tea beverages into two cups 108). As also shown in FIG. 9, an ice maker 202 is provided on either side of the apparatus 200. Like apparatus 100, apparatus 200 has a width dimension of no more than about four feet. FIG. 10 shows an embodiment in which two apparatus 200 are separated by an ice maker 202. In the embodiment shown in FIG. 10, each of the apparatus 200 again has a width dimension of no more than about four feet. The ice maker 202 has a width dimension of no more than about one foot. Thus, the embodiment shown in FIG. 10 has a total width dimension of no more than about nine feet.

As has been described, the present invention provides a method and apparatus for the automated brewing of a beverage in an apparatus that occupies a small amount of space and for dispensing the brewed beverage at a relatively constant temperature. As has also been described, the apparatus is self-cleaning.

While this invention has been described in conjunction with exemplary embodiments outlined above and illustrated in the drawings, it is evident that many alternatives, modifications and variations in form and detail will be apparent to those skilled in the art. Accordingly, the exemplary embodiments of the invention, as set forth above, are intended to be illustrative, not limiting, and the spirit and scope of the present invention is to be construed broadly and limited only by the appended claims, and not by the foregoing specification.

What is claimed is:

1. An apparatus for brewing a beverage, comprising:
a brew station configured to brew a beverage concentrate using hot water;
a heat exchanger configured to cool the beverage concentrate from a first temperature to a predetermined second temperature; and
a storage receptacle in fluid communication with the heat exchanger to hold the beverage concentrate received from an output of the heat exchanger, wherein the temperature of the beverage concentrate is further cooled from the second temperature to the third temperature while the beverage concentrate is held in the storage receptacle;
wherein upon completion of brewing the beverage concentrate, the apparatus compares an actual level of the beverage concentrate in the storage receptacle to an anticipated level of the beverage concentrate.

2. The apparatus of claim 1, wherein the apparatus disables future brews of beverage concentrate if it determines that the actual level of the beverage concentrate in the storage receptacle does not correspond to the anticipated level.

3. An apparatus for brewing a beverage, comprising:
a brew station configured to brew a beverage concentrate using hot water;
a heat exchanger configured to cool the beverage concentrate from a first temperature to a predetermined second temperature; and
a storage receptacle in fluid communication with the heat exchanger to hold the beverage concentrate received from an output of the heat exchanger, wherein the temperature of the beverage concentrate is further cooled from the second temperature to the third temperature while the beverage concentrate is held in the storage receptacle;
wherein the apparatus forecasts estimated times for the next brews of the beverage concentrate.

4. The apparatus of claim 3, wherein the apparatus subtracts an average hourly depletion of the beverage concentrate in the storage receptacle from a current weight of the beverage concentrate in the storage receptacle to calculate the estimated times.

5. The apparatus of claim 3, wherein the apparatus displays the estimated times for the next brews of the beverage concentrate.

6. The apparatus of claim 3, comprising a plurality of storage receptacles, wherein the apparatus forecasts the estimated times for the next brews of the beverage concentrate for each one of the plurality of storage receptacles.

7. The apparatus of claim 6, wherein the apparatus displays the estimated times for the next brews of the beverage concentrate for each one of the plurality of storage receptacles.

8. The apparatus of claim 6, wherein, for each one of the plurality of storage receptacles, the apparatus subtracts an average hourly depletion of the beverage concentrate in the storage receptacle from a current weight of the beverage concentrate in the storage receptacle to forecast the estimated time.

9. The apparatus of claim 6, wherein the apparatus displays the estimated times for the next brews of the beverage concentrate for each one of the plurality of storage receptacles.
